(19) United States
(12) Patent Application Publication
(10) Pub. No.: US 2023/0411829 A1
(43) Pub. Date: Dec. 21, 2023

(54) ANTENNA ASSEMBLIES WITH PRINTED CIRCUIT PARASITIC ANTENNA ELEMENTS

(71) Applicant: HEWLETT-PACKARD DEVELOPMENT COMPANY, L.P., Spring, TX (US)

(72) Inventors: Yung-Chang Wei, Taipei City (TW); Ching-Hung Ma, Taipei City (TW); Ren-Hao Chen, Taipei City (TW); Kun-Jung Wu, Taipei City (TW)

(21) Appl. No.: 17/807,777

(22) Filed: Jun. 20, 2022

(51) Int. Cl. H01Q 1/24; H01Q 1/38

(52) U.S. Cl. CPC H01Q 1/24; H01Q 1/38

(57) ABSTRACT

In some examples, an antenna assembly includes a driven antenna element to communicate a signal over an antenna feed line, and a printed circuit including an electrically conductive pattern that is placed adjacent the driven antenna element. The printed circuit including the electrically conductive pattern provides a parasitic antenna element for the driven antenna element.

### BACKGROUND

Some electronic devices are able to communicate wirelessly over wireless connections with other electronic devices. Wireless connections can include connections over cellular networks, connections over wireless local area networks (WLANs), connections over BLUETOOTH links, connections over radio frequency identification (RFID) links, and so forth.

### BRIEF DESCRIPTION OF THE DRAWINGS

Some implementations of the present disclosure are described with respect to the following figures.

FIG. 1A is an exploded top perspective view of a portion of an electronic device that includes an antenna according to some examples.

FIG. 1B is an exploded bottom perspective view of a portion of an electronic device including an antenna according to some examples.

FIGS. 2A-2B are schematic side sectional views illustrating an antenna assembly according to some examples.

FIG. 3 is a block diagram of an antenna assembly according to some examples.

FIG. 4 is a block diagram of an electronic device according to some examples.

FIG. 5 is a flow diagram of a process of forming an antenna assembly in an electronic device, according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

Examples of electronic devices with wireless communication capabilities can include notebook computers, tablet computers, desktop computers, all-in-one (AIO) computers, smartphones, game appliances, wearable devices, head-mounted devices, Internet-of-Things (IoT) devices, or other types of electronic devices, for example, imaging devices such as printers or additive manufacturing devices (3D printers).

Electronic devices can include antennas to allow the electronic devices to perform wireless communications. Such electronic devices with wireless communication capabilities can be referred to as wireless electronic devices. As the form factors for electronic devices become smaller, antenna performance can suffer as the amount of space in which antennas can be placed is reduced, due to reduced signal strengths of antenna signals and potential interference with other components in the electronic devices.

In some examples, a portion of a metal chassis (or more generally, an electrically conductive chassis) for an electronic device can be designed to be part of an antenna of the electronic device, to improve antenna performance. An example way to accomplish this is to form a generally L-shaped slot (or slot of another shape) in the metal chassis and fill the slot with a non-conductive material (which does not conduct electricity or conducts electricity at less than a specified threshold, e.g., the resistivity of the non-conductive material exceeds a specified resistivity threshold). The non-conductive material can include plastic, ceramic, fiber glass, nylon, or another type of non-conductive material.

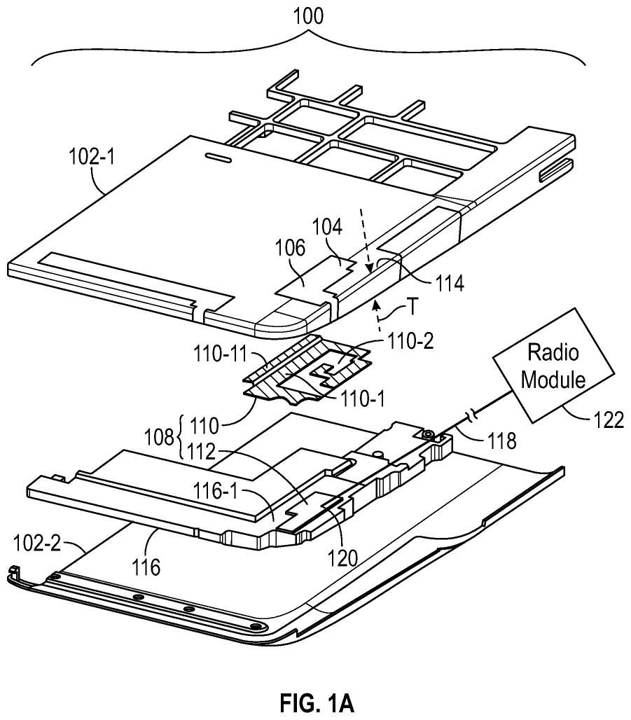

An example of using a portion of an electrically conductive chassis as part of the antenna is shown in FIG. 1A, which is an exploded upper perspective view of a portion of an upper housing segment 102-1 and a portion of a lower housing segment 102-2 of an electronic device 100. FIG. 1B is an exploded bottom perspective view of the portion of the electronic device 100.

The upper housing segment 102-1 and the lower housing segment 102-2 can be formed of a metal (e.g., aluminum or another metal) or another rigid material. The upper housing segment 102-1 and the lower housing segment 102-2 are attached together to form a housing (also referred to as “chassis”) of the electronic device 100. The housing of the electronic device 100 defines an inner space in which components of the electronic device 100 are mounted.

A generally L-shaped slot 104 is formed on a right, lower side of the upper housing segment 102-1 in the view of FIG. 1A. A “generally L-shaped slot” can refer to any opening in the upper housing segment 102-1 that has a shape similar to an L. The generally L-shaped slot 104 extends through the entire thickness T of the upper housing segment 102-1. The generally L-shaped slot 104 is filled with a non-conductive material 106, such as plastic or a different non-conductive material. In some examples, the non-conductive material 106 is insert molded with the upper housing segment 102-1.

The generally L-shaped slot 104 has one turn, which means that the slot has a first portion and a second portion that is angled (non-zero angle) with respect to the first portion. More generally, the slot 104 filled with the non-conductive material 106 can have multiple turns.

The generally L-shaped slot 104 is located such that it is proximate an antenna assembly 108 that includes an intermediate antenna element 110 and a driven antenna element 112 (details of the antenna assembly 108 are discussed further below). Due to the presence of the generally L-shaped slot 104, a portion of the upper housing segment 102-1 adjacent the generally L-shaped slot 104 forms a parasitic antenna element 114 for the antenna assembly 108. The parasitic antenna element 114, which is generally reverse L-shaped to correspond to the generally L-shaped slot 104, is part of an overall antenna that also includes the antenna assembly 108. In other examples, the parasitic antenna element 114 can have a different shape. The portion of the upper housing segment 102-1 that forms the parasitic antenna element 114 includes an electrically conductive material, such as the metal or other electrically conductive material used to form the upper housing segment 102-1. The metal can include aluminum, magnesium, and so forth.

Since the upper housing segment 102-1 is grounded, the parasitic antenna element 114 is also electrically connected to ground of the electronic device 100.

Although examples refer to forming the parasitic antenna element 114 in the upper housing segment 102-1, in other examples, a parasitic antenna element can instead or additionally be formed in the lower housing segment 102-2, and/or in a side housing segment.

A parasitic antenna element of an antenna is also referred to as a passive resonator, since the parasitic antenna element is not electrically connected to an antenna feed line. The antenna feed line can be electrically connected to a signal transceiver (including a signal transmitter and a signal receiver). In examples in which the electronic device 100 communicates radio signals, the wireless transceiver can be part of a radio module. The parasitic antenna element modifies a radiation pattern of signal waves emitted by a driven antenna element (which is the antenna element electrically connected to the antenna feed line). For example, the parasitic antenna element can direct the signal waves in a certain direction to increase the antenna's impedance matching and antenna bandwidth. The parasitic antenna element absorbs signal waves from the driven antenna element that is near the parasitic antenna element, and the parasitic antenna element re-radiates the signal waves, such as in a different phase. The signal waves of the parasitic antenna element and the driven antenna element interfere with one another, such that the signal waves are strengthened in a given direction (or given directions), and cancelled or attenuated in other direction(s).

An issue with an antenna that includes a parasitic antenna element formed with an electrically conductive portion of the housing of an electronic device is that the antenna can be sensitive to interference by an external object, such as a user's hand (or finger), a digital stylus, and so forth. Interference with the antenna by the external object reduces the performance of the antenna.

In accordance with some implementations of the present disclosure, to address issues associated with reduced antenna performance with antennas that include parasitic antenna elements formed with an electrically conductive portion of a chassis of an electronic device (e.g., the electronic device 100 of FIG. 1A), the intermediate antenna element 110 is added as part of the antenna. With the arrangement shown in FIG. 1A, the antenna includes the driven antenna element 112, the intermediate antenna element 110, and the parasitic antenna element 114.

In other examples, the parasitic antenna element 114 of the upper housing segment 102-1 can be omitted. Instead, the portion of the upper housing segment 102-1 next to the antenna assembly 108 can be formed with a non-conductive material such that a parasitic antenna element is not formed in the upper housing segment 102-1.

The intermediate antenna element 110 includes a printed circuit with an electrically conductive pattern, which can be formed using electrically conductive traces that can meander in a number of different directions. The traces of the printed circuit can be formed with copper, nickel, aluminum, or another electrically conductive material. The printed circuit with the electrically conductive pattern is not electrically connected to the driven antenna element 112 of the antenna assembly 108, but rather the printed circuit with the electrically conductive pattern acts as a parasitic antenna element for the driven antenna element 112 to improve the performance of the antenna assembly.

FIGS. 1A-1B show some example components contained in an inner space defined by the upper and lower housing segments 102-1 and 102-2 when the housing segments 102-1 and 102-2 are attached together. Other components inside the electronic device 100 are omitted for better clarity.

An example component that can be mounted in the inner space of the housing by attaching the upper and lower housing segments 102-1 and 102-2 is a speaker assembly 116 of the electronic device 100. The speaker assembly 116 includes a speaker to output audio, as well as associated electronics for the speaker.

In some examples, the driven antenna element 112 is mounted on a surface 116-1 of the speaker assembly 116. Although the example shows the driven antenna element 112 mounted on the speaker assembly 116, in other examples, the driven antenna element 112 can be mounted on a different component or other structure in the electronic device 100.

As further shown in FIG. 1A, an antenna feed line 118 is electrically connected to the driven antenna element 112. An “antenna feed line” can refer to an arrangement of electrical conductors to communicate signals to and from the driven antenna element 112. For example, the antenna feed line 118 can be in the form of a coaxial cable. In other examples, the antenna feed line 118 can be formed of electrical wires, or electrical conductors such as traces in a substrate, such as the substrate of the speaker assembly 116, and so forth.

The antenna feed line 118 is connected to a feed point 120 on the driven antenna element 112. Another point on the driven antenna element 112 is connected to ground (not shown).

In some examples, the driven antenna element 112 can be formed of an electrically conductive material, such as in the form of a structure that has multiple portions, where a portion of the structure can be wider than another portion. The driven antenna element 112 corresponds to the generally reverse L-shaped parasitic antenna element 114 of the upper housing segment 102-1.

In other examples, the driven antenna element 112 can have a different shape.

The intermediate antenna element 110 is not electrically connected to any antenna feed line, including the antenna feed line 118. The intermediate antenna element 110 is electrically isolated at direct current (DC). A DC signal has zero frequency.

The intermediate antenna element 110 has an electrically conductive pattern 110-1 (e.g., a pattern of an electrically conductive trace such as a copper trace, an aluminum trace, a nickel trace, etc.) formed on a substrate 110-2. The substrate 110-2 can be in the form of a printed circuit, such as a flexible printed circuit (FPC), a circuit board, or another type of printed circuit. The substrate 110-2 is formed of an electrically non-conductive (dielectric) material, such as polyimide, polyethylene terephthalate (PET), polyethylene naphthalate (PEN), polybetrefluoroethylene (PTFE), and so forth.

Since the substrate 110-2 is electrically non-conductive, the substrate 110-2 is not electrically contacted to the driven antenna element 112 (at DC), even if the substrate 110-2 physically touches the driven antenna element 112. In some examples, there may be an air gap between the substrate 110-2 and the driven antenna element 112.

The electrically conductive pattern 110-1 has multiple segments that are arranged in a meandering pattern on the upper surface of the substrate 110-2. The multiple segments of the electrically conductive pattern 110-1 are angled with respect to one another (i.e., the electrically conductive pattern 110-1 has multiple turns). The pattern of the electrically conductive pattern 110-1 is designed to create a target interference with respect to antenna signals of the driven antenna element 112 to improve impedance matching and antenna bandwidth.

The electrically conductive pattern 110-1 also includes a raised portion 110-11 that is raised above the rest of the electrically conductive pattern 110-1 formed on the upper surface of the substrate 110-2. In other examples, the raised portion 110-11 may not be present.

The upper surface of the intermediate antenna element 110 is attached to an inside surface 102-11 of the upper housing segment 102-1, as shown in FIG. 1B. In some examples, the attachment of the intermediate antenna element 110 to the inside surface 102-11 of the upper housing segment 102-1 can be based on use of a non-conductive (dielectric) adhesive layer between the intermediate antenna element 110 and the upper housing segment 102-1. The non-conductive adhesive is non-electrically conductive at DC.

The antenna feed line 118 is connected to a radio module 122, which can include a signal transceiver that transmits radio signals over the antenna feed line 118 to the driven antenna element 112 and receives radio signals from the driven antenna element 112 over the antenna feed line 118.

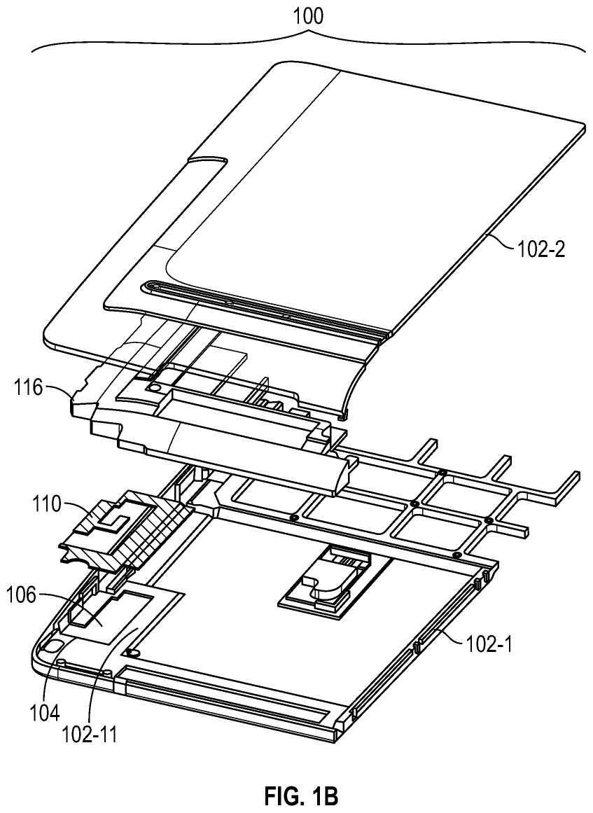

Schematic sectional side views of a portion of the upper housing segment 102-1 and the antenna assembly according to some examples is shown in FIGS. 2A-2B.

The intermediate antenna element 110 includes an electrically conductive layer (e.g., a copper layer), which includes electrically conductive portions 110-12 and 110-13 in the view of FIGS. 2A-2B. The electrically conductive portions 110-12 and 110-13 are part of the electrically conductive pattern 110-1 of FIG. 1A.

The intermediate antenna element 110 also includes a substrate layer that forms the substrate 110-2. As shown in FIG. 2A, a relatively thin dielectric adhesive layer 202 attaches the intermediate antenna element 110 to the inside surface 102-11 of the upper housing segment 102-1. In some examples, the thickness of the dielectric adhesive layer 202 can range between 0.02 millimeters (mm) to 0.03 mm, or can be less than 0.05 mm, or can be less than 0.1 mm, or can have another example thickness.

The slot 104 extends through the thickness T of the upper housing segment 102-1. The slot 104 is filled with the non-conductive material 106.

The intermediate antenna element 110 is formed over the driven antenna element 112. In some examples, it is possible to have intermediate layer(s) between the intermediate antenna element 110 and the driven antenna element 112.

FIG. 2B shows an equivalent capacitor 204-1 between the electrically conductive portion 110-12 and the upper housing segment 102-1, and an equivalent capacitor 204-2 between the electrically conductive portion 110-13 and the upper housing segment 102-1.

At radio frequencies, or at other relatively high frequencies, the capacitors 204-1 and 204-2 are short circuits between the electrically conductive pattern 110-1 and the portion of the upper housing segment 102-1 that forms the parasitic antenna element 114.

As a result, since the parasitic antenna element 114 is grounded to the upper housing segment 102-1, at RF frequencies or other higher frequencies, the electrically conductive pattern 110-1 of the intermediate antenna element 110 is also grounded.

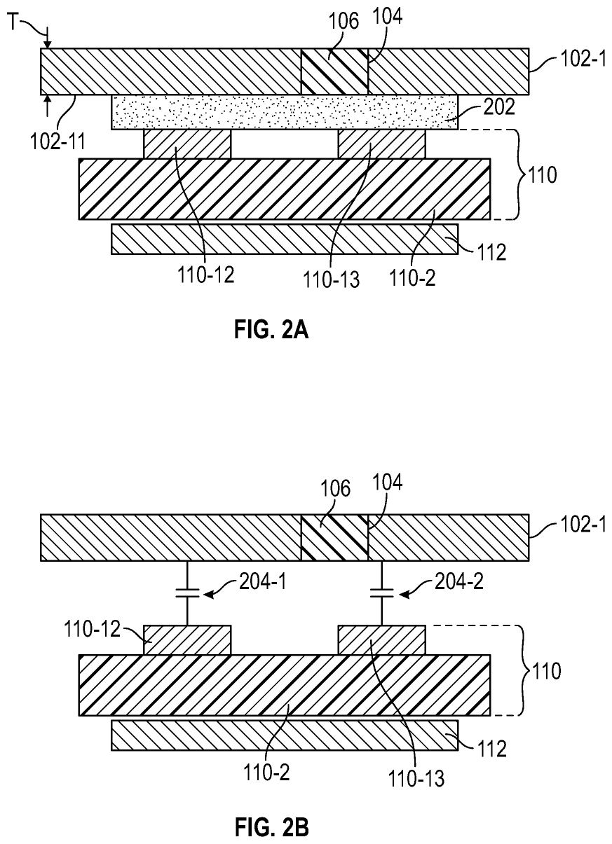

FIG. 3 is a block diagram of an antenna assembly 300 according to some examples. The antenna assembly 300 includes a driven antenna element 302 (e.g., similar to 112 in FIG. 1A) to communicate a signal over an antenna feed line (e.g., 118 in FIG. 1A).

The antenna assembly 300 includes a printed circuit 304 that has an electrically conductive pattern 306 that is placed adjacent the driven antenna element 302. The printed circuit 304 including the electrically conductive pattern 306 provides a parasitic antenna element for the driven antenna element. The printed circuit 304 that has the electrically conductive pattern 306 is “adjacent” the driven antenna element 302 if the electrically conductive pattern 306 is sufficiently close to the driven antenna element 302 such that the electrically conductive pattern 306 can interfere with antenna signals of driven antenna element 302 to improve impedance matching to achieve increased antenna bandwidth (and thus gain), which can mitigate against interference by external adjacent objects.

In some examples, the antenna assembly 300 further includes an electrically conductive portion of a housing of an electronic device, where the electrically conductive portion of the housing provides a further parasitic element (e.g., 114 in FIG. 1A) for the driven antenna element 302.

In some examples, the housing of the electronic device includes a non-conductive slot (e.g., 104 in FIG. 1A) adjacent the electrically conductive portion of the housing.

In some examples, the non-conductive slot contains a layer of a non-conductive material (e.g., 106 in FIG. 1A) inserted (e.g., insert molded) into the housing.

In some examples, the printed circuit 304 includes a flexible printed circuit or a circuit board.

In some examples, the electrically conductive pattern 306 on the printed circuit 304 includes a metal trace with a plurality of turns.

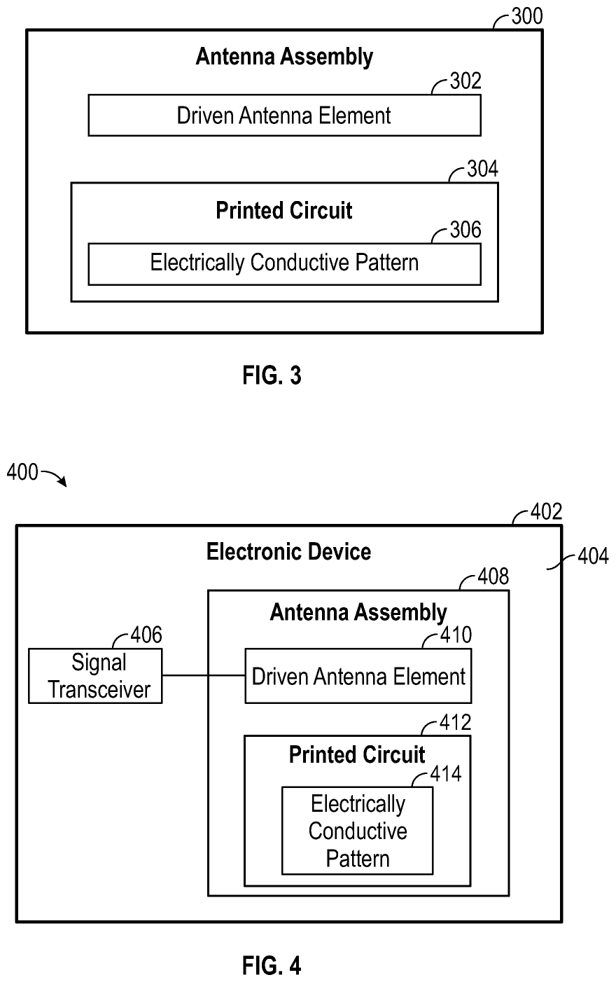

FIG. 4 is a block diagram of an electronic device 400 according to some examples. The electronic device 400 includes a housing 402 defining an inner space 404.

The electronic device 400 includes a signal transceiver 406 in the inner space 404. The signal transceiver 406 can be part of the radio module 122 of FIG. 1A, for example.

The electronic device 400 includes an antenna assembly 408 in the inner space 404. The antenna assembly 408 includes a driven antenna element 410 electrically connected to the signal transceiver 406.

The antenna assembly 408 further includes a printed circuit 412 having an electrically conductive pattern 414 that is placed adjacent the driven antenna element 410. The printed circuit 412 having the electrically conductive pattern 414 provides a parasitic antenna element for the driven antenna element 410.

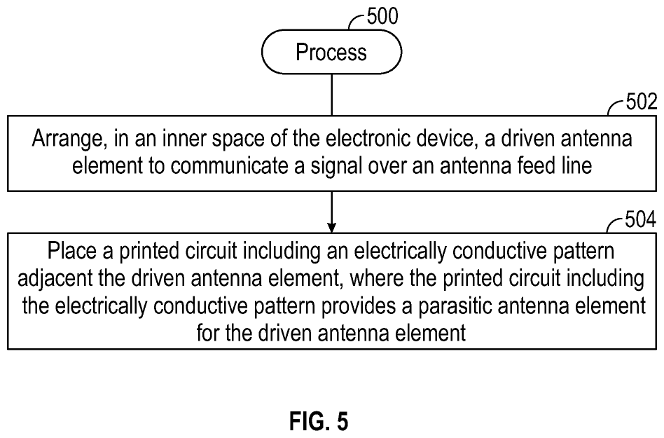

FIG. 5 is a flow diagram of a process 500 of forming an antenna assembly in an electronic device, according to some examples.

The process 500 includes arranging (at 502), in an inner space of the electronic device, a driven antenna element to communicate a signal over an antenna feed line.

The process 500 includes placing (at 504) a printed circuit including an electrically conductive pattern adjacent the driven antenna element, where the printed circuit including the electrically conductive pattern provides a parasitic antenna element for the driven antenna element.

By employing the intermediate antenna element 110 that acts as a parasitic antenna element for a driven antenna element, the performance of an antenna assembly can be improved, by improving impedance matching and antenna bandwidth of the antenna assembly, for example. Also, reduced performance caused by interference with an external object (e.g., a user's hand or finger, a stylus, etc.) of the antenna assembly can be mitigated, due to the presence of the intermediate antenna element 110. Also, by using the intermediate antenna element 110, the mechanical strength of the housing of the electronic device does not have to be compromised by increasing the size of the non-conductive slot (e.g., the slot 104 in FIG. 1A) to provide a larger parasitic antenna element.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An antenna assembly comprising:
a driven antenna element to communicate a signal over an antenna feed line; and
a printed circuit comprising an electrically conductive pattern that is placed adjacent the driven antenna element, the printed circuit comprising the electrically conductive pattern providing a parasitic antenna element for the driven antenna element.

2. The antenna assembly of claim 1, further comprising:
an electrically conductive portion of a housing of an electronic device, the electrically conductive portion of the housing providing a further parasitic element for the driven antenna element.

3. The antenna assembly of claim 2, further comprising a non-conductive slot adjacent the electrically conductive portion of the housing.

4. The antenna assembly of claim 3, wherein the non-conductive slot contains a layer of a non-conductive material inserted into the housing.

5. The antenna assembly of claim 4, wherein the non-conductive material is insert molded into an opening in the housing to form the non-conductive slot.

6. The antenna assembly of claim 4, wherein the non-conductive material comprises plastic.

7. The antenna assembly of claim 1, wherein the printed circuit comprises a flexible printed circuit.

8. The antenna assembly of claim 1, wherein the printed circuit comprises a circuit board.

9. The antenna assembly of claim 1, wherein the electrically conductive pattern on the printed circuit comprises a metal trace with a plurality of turns.

10. The antenna assembly of claim 9, wherein the printed circuit with the electrically conductive pattern is to attach to an inner surface of a housing of an electronic device.

11. The antenna assembly of claim 10, further comprising a dielectric adhesive layer to attach the printed circuit with the electrically conductive pattern to the inner surface of the housing.

12. An electronic device comprising:
a housing defining an inner space;
a signal transceiver in the inner space; and
an antenna assembly in the inner space, the antenna assembly comprising:
a driven antenna element electrically connected to the signal transceiver, and
a printed circuit comprising an electrically conductive pattern that is placed adjacent the driven antenna element, the printed circuit comprising the electrically conductive pattern providing a parasitic antenna element for the driven antenna element.

13. The electronic device of claim 12, wherein the housing comprises an electrically conductive portion next to the antenna assembly, the electrically conductive portion of the housing providing a further parasitic antenna element for the driven antenna element.

14. The electronic device of claim 13, wherein the electrically conductive portion of the housing that provides the further parasitic antenna element is defined by a slot inserted with a non-conductive material in the housing, and wherein the slot comprises a turn.

15. A method of forming an antenna assembly in an electronic device, comprising:
arranging, in an inner space of the electronic device, a driven antenna element to communicate a signal over an antenna feed line; and
placing a printed circuit comprising an electrically conductive pattern adjacent the driven antenna element, the printed circuit comprising the electrically conductive pattern providing a parasitic antenna element for the driven antenna element.
